(19) United States
(12) Patent Application Publication
(10) Pub. No.: US 2005/0015516 A1
(43) Pub. Date: Jan. 20, 2005

(54) IP appliance connectable with handheld device

(76) Inventor: Pay-Lun Ju, Cupertino, CA (US)

Correspondence Address: Andrew Romero;Renner, Otto, Boisselle & Sklar, LLP, Nineteenth Floor, 1621 Euclid Avenue, Cleveland, OH, 44115-2191, US

(21) Appl. No.: 10/619,788

(22) Filed: Jul. 14, 2003

(51) Int. Cl. G06F 15/16

(52) U.S. Cl. 709/250

(57) ABSTRACT

An Internet Protocol (IP) appliance and a method of using such appliance is disclosed. The IP appliance includes an IP telephone, an IP appliance universal connector and a network connector. A handheld device can be operationally connected to the IP appliance via the IP appliance universal connector to transmit and receive data over an IP network and/or a PSTN network.

### TECHNICAL FIELD

The present invention generally relates to Internet Protocol (IP) telephony and, more specifically, relates to an IP appliance connectable with a handheld device.

### BACKGROUND ART

IP telephony is a collection of technologies that emulates and extends today's circuit-switched telecommunications services to operate on packet-switched data networks based on the Internet Protocol (IP). IP telephony encompasses the terms “Internet Telephony”, “Voice-over-IP” (VoIP), “video-over-IP”, and “fax-over-IP”, and extends those capabilities even further to include new telecommunications applications made possible by the convergence of voice, video and data. “Voice-over-IP” (VoIP) technology enables the real-time transmission of voice signals as packetized data over “IP networks” that employ the Transmission Control Protocol (TCP), Real-Time Transport Protocol (RTP), User Datagram Protocol (UDP), and Internet Protocol (IP) suite, for example.

A conventional Public Switched Telephone Network (PSTN) provides users with dedicated, end-to-end circuit connections for the duration of each call. Based on the calling and called parties' numbers, circuits are reserved among an originating switch, any tandem switches along the route between the two ends of the call, and a terminating switch. Signaling between these PSTN switches supports basic call setup, call management, and call teardown as well as querying of databases to support advanced services such as local number portability, mobile subscriber authentication and roaming, virtual private networking, and toll-free service.

The conventional PSTN has served voice traffic well over the last 100 years, but its success has been paralleled by a rise of separate networks to support voice and data traffic. These separate networks include, for example, the World-Wide Web which is commonly referred to as the Internet, an Intranet, a wide-area network (WAN), a local area network (LAN), an ATM, a T1 network, an E1 network, an Ethernet, a microwave network, a satellite network or the like, or a combination thereof. Additionally, wireless phone networks, e.g., cellular or cell phone networks, have been implemented. Cell phone networks use radio waves to transmit data between a cell phone and a tower.

Clearly, use of distinct networks for voice and data represents an additional burden to service providers and an additional cost to consumers. As more and more PSTN traffic becomes data-oriented, however, the trend toward voice and data network convergence becomes stronger and stronger. Service providers, Internet service providers, and manufacturers of switching, transmission, and customer premises equipment are all participating in a significant shift of the telecommunications industry toward combined voice/video/data networking using IP.

The shift to IP telephony promises better efficiencies in the transport of voice and data, and, as a result, lower telecommunications costs to end users. Moreover, as IP telephony evolves, it will be able to match all the features of voice communications currently supported by the PSTN. Interoperability among the IP telephony products of different vendors is the first major hurdle to overcome. The real promise of IP telephony, however, will be realized with the next wave of advanced services that will begin to surpass the capabilities of the PSTN.

Additionally, handheld devices, for example, a PalmOS organizer, a Windows based organizer or the like, have been designed to organize and increase the productivity of mobile users. That is, most handheld devices include relatively fast microprocessors and sufficient memory to run classic applications, for example, a phone book, calendar, to-do list, memos. Some handheld devices run “mobile” versions of applications commonly found on a PC including, for example, applications for word processing, spreadsheets, presentations and displaying images or video. Additionally, there are thousands of other applications that can be used on a handheld device that create data that the mobile user may want to transfer or backup on a conventional personal computer (PC). For example, the mobile user can synchronize such data using a synchronization application. The data can be synchronized with applications on the mobile user's PC via a wireless or cable connection. Handheld devices can also retrieve and display data, for example, e-mail with attachments, music files or the like.

Current IP telephone appliances are not compatible with handheld devices. Accordingly, a user must carry one or more handheld devices, for example a PDA, a cell phone, a pager, an MP3 player or a combination thereof, to maintain connectivity with information (data) maintained on an IP network or on a PC attached to an IP network. Further, the user of a cell phone or a combination phone/PDA must use relatively expensive minutes to make and receive calls, send or receive data, etc. using conventional methods.

Therefore, there exists a strong need in the art for an IP appliance that is capable of operationally connecting with a handheld device and utilizes a network including a VoIP network and/or a PSTN network. Such an appliance and method of using the same would allow a user to complete a call more cost effectively and maintain connectivity with information or data stored on devices connected to the network.

### SUMMARY OF THE INVENTION

According to one aspect of the invention, the invention is an Internet Protocol (IP) appliance, comprising: an IP telephone including a housing; an IP appliance connector mounted to the housing and configured to operationally connect with a connector of a handheld device; and a network connector mounted to the housing and configured to operationally connect to a network; wherein when the handheld device is operationally connected to the IP appliance connector, the handheld device can transmit and receive data via the network.

According to another aspect of the invention, the invention is a method for using a handheld device connected to an IP appliance, wherein the IP appliance comprises; an IP telephone including; an IP appliance connector for connecting with a handheld device; a connector for connecting to a VoIP network; a microphone for receiving voice data; and a speaker for transmitting voice data; comprising the steps of: (a) operationally connecting the handheld device to the IP appliance; (b) operationally connecting to a network via a network connector mounted to an IP appliance housing; and (c) transmitting and receiving data via the network.

### BRIEF DESCRIPTION OF DRAWINGS

These and further features of the present invention will be apparent with reference to the following description and drawings, wherein:

FIG. 1 is a schematic perspective view of an IP appliance including an IP telephone, an IP appliance universal connector and a handheld device operationally connectable to the IP appliance via the IP appliance universal connector according to an embodiment of the present invention;

FIG. 2 is a schematic perspective view of the IP appliance of FIG. 1 with the handheld device operationally connected to the IP appliance according to an embodiment of the present invention;

FIG. 3A is a schematic bottom plan view of a handheld device connector on a handheld device compatible with the IP appliance universal connector of FIG. 1 according to an embodiment of the present invention;

FIG. 3B is a schematic bottom plan view of another handheld device connector on another handheld device compatible with the IP appliance universal connector of FIG. 1 according to another embodiment of the present invention;

FIG. 4 is a detailed block diagram of the IP appliance in accordance with an exemplary embodiment of the present invention;

FIG. 5 is a system level diagram representing a handheld device operationally connected to one or more devices on one or more networks via the IP appliance of FIG. 1 to exchange data with the one or more devices according to an embodiment of the present invention; and

FIG. 6 is a flow diagram of a method for employing the handheld device operationally connected to the IP appliance of FIG. 1 according to the present invention.

### DISCLOSURE OF INVENTION

To illustrate the present invention in a clear and concise manner, the drawings may not necessarily be to scale and certain features may be shown in a partial schematic format. Like reference numerals are used to refer to like elements throughout.

The present invention is an Internet Protocol (IP) appliance that includes an IP telephone having an IP appliance connector (wired or wireless, as further described below) for operationally connecting a handheld device thereto. The IP appliance is operationally connected to a network including a VoIP network to make and/or receive VoIP calls using features of the IP telephone and/or features of the handheld device. In one embodiment, the IP appliance is operationally connected to a network including a PSTN network in order to make and/or receive PSTN calls using features of the IP telephone and/or features of the handheld device. In one embodiment, the IP appliance connector operationally connects the handheld device to a network to transmit and receive data including, for example, voice, video and/or other data.

Accordingly, the IP appliance of the present invention increases the productivity and connectivity of the user by providing greater control and access to information. Further, the IP appliance produces financial savings to the user. For example, the user can make a long distance call over a VoIP network using a contact list containing a contact's phone number maintained on a handheld device. The long distance call made over the VoIP system is usually at a significantly reduced rate compared to a conventional long distance call made over a conventional PSTN network. Further, the user can synchronize new information added to the contact list with contact lists maintained on other platforms, for example, a PC, laptop, cell phone, combination phone/PDA, or the like. In essence, the user can now maintain “one contact list” regardless of whether the user is using the handheld device, the IP appliance, the PC, or another handheld device.

The IP appliance of the present invention also allows the user to maintain connectivity with information (data) maintained on an IP network or on a device such as a PC or another handheld device, e.g., PDA, cell phone, MP3 player, or the like, or a combination thereof, attached to the IP network. In other words, the handheld device can transmit and receive data over an IP network via the IP appliance. For example, a user can transfer files between a PC and the handheld device. In the case where the files are transferred to the handheld device, the user can work on the files later when the user is not connected to the IP network. When the user subsequently connects to the IP network, the user can synchronize those files with the files maintained on the PC.

Further still, the handheld device connected to the network via the IP appliance can be configured to automatically retrieve e-mail and/or voice messages maintained on devices connected to the network. Additionally, the universal connector of the IP appliance can be configured to charge a battery of the handheld device when the handheld device is operationally connected thereto.

Also, when the handheld device is operationally connected to the IP appliance, the IP appliance can use the display of the handheld device to run applications on the IP appliance and/or on other devices connected to the network. For example, a user could select a phone number of a contact displayed on the handheld display by touching the number on the display. Various options could be displayed to the user including, for example, call, update, erase or the like. If the user selects “call” on the handheld device display, the number is “dialed” by the IP appliance. The call may be connected using the VoIP network and/or the PSTN network. Thus, the present invention saves time, money, increases efficiency and increases productivity while maintaining connectivity with information contained on the various voice and data networks.

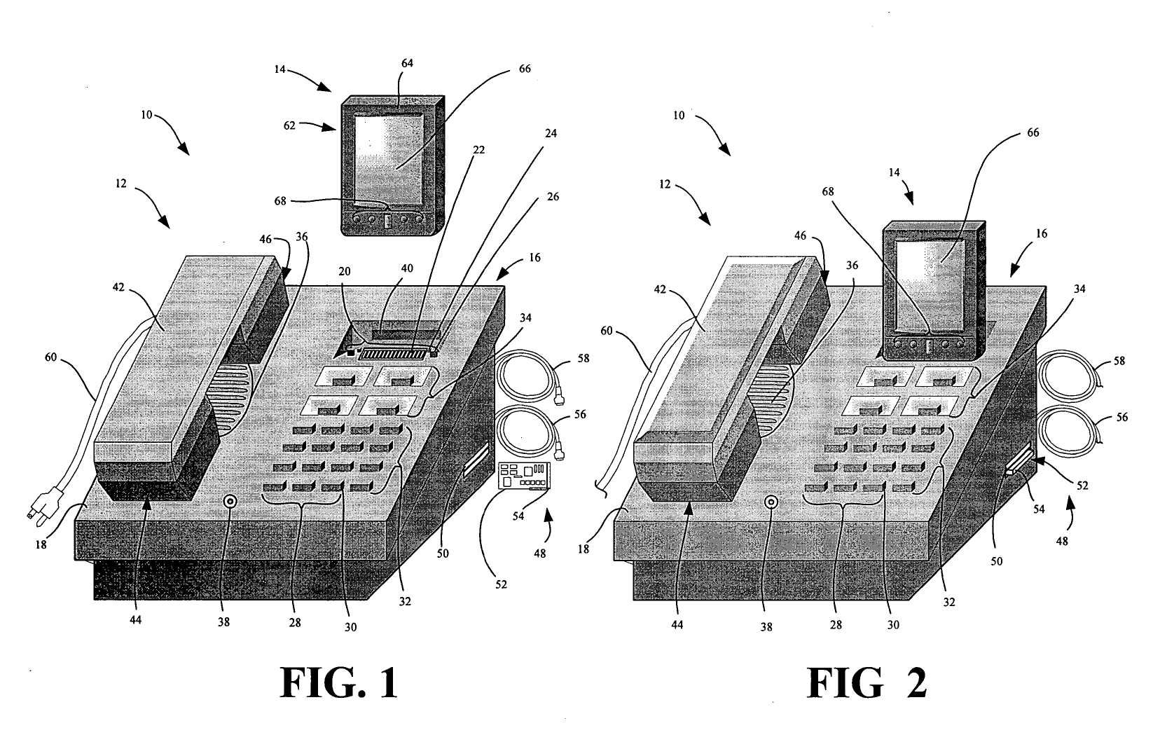

Referring initially to FIG. 1, an embodiment of an IP appliance, generally designated as 10, is shown. The IP appliance 10 includes an IP telephone generally designated as 12. The IP appliance 10 is connectable to a network over which data such as voice, video, or other type data, is transmitted and received. The IP appliance 10 is configured to operationally connect with a first handheld device generally designated as 14. Once the first handheld device 14 is operationally connected to the IP appliance 10, the first handheld device 14 can transmit and receive data over the network (as further described below). Further, a user can use applications on the first handheld device 14 to run applications on the IP telephone 12.

The IP appliance 10 includes an IP appliance housing 16 that may be shaped like a conventional desktop or wall mounted telephone set, for example. The IP appliance housing 16 includes an IP appliance faceplate 18. Within the IP appliance housing 16, there are components, for example, a hard drive, microprocessor, memory, etc., configured to store and run an operating system and applications to operationally function as an IP appliance connectable to a network as further described below. In order to focus on the present invention, the particular details of such components and configuration have been omitted for the sake of brevity. Nevertheless, those having ordinary skill in the art will easily understand how such parts are implemented.

An IP appliance universal connector 20 is located on the IP appliance faceplate 18. Components of the IP appliance universal connector 20 may partially extend from the IP appliance faceplate 18 or be accessed therethrough. The IP appliance universal connector 20 can be used to connect to a compatible connector contained on the first handheld device 14. In one embodiment, an IP appliance connector uses a wireless protocol, e.g., IR, 802.11x, Bluetooth, or the like, and associated hardware and software.

The IP appliance universal connector 20 includes IP appliance universal connector pins 22, an IP appliance universal connector primary locking pin 24 and an IP appliance universal connector secondary locking pin 26. The IP universal connector pins 22 are used to electrically couple the first handheld device 14 to the IP appliance 10 in an operational configuration. The term “operational” is used to describe the capability of the handheld device 14 to perform a process via the IP appliance 10 or the IP appliance to perform a process on the handheld device 14. The process may be to transmit and receive data therebetween, for example.

In one embodiment, the IP appliance universal connector primary locking pin 24 may be spring-loaded. In another embodiment, the IP appliance universal connector primary locking pin 24 may have a flange extending from a locking end of the IP appliance universal connector primary locking pin 24. The universal secondary locking pin 26 may be configured similar to the IP appliance universal connector primary locking pin 24. Alternatively, the universal secondary locking pin 26 may be configured different from the IP appliance universal connector primary locking pin 24. Further, the universal secondary locking pin 26 may be made larger or smaller than the IP appliance universal connector primary locking pin 24. When the IP appliance 10 is connected wirelessly to a handheld device 14, a locking mechanism is not required. However, a locking mechanism may be provided to physically secure the handheld device 14 in the IP appliance 10 for the convenience of the user. Alternatively, the locking mechanism described above may be provided to physically secure the handheld device 14 to the IP appliance 10 for charging the handheld device as described below.

Additionally, the IP appliance faceplate 18 contains many of the components commonly found on a conventional telephone set. The following components described are merely exemplary of the types of components that can be incorporated into the housing of the IP appliance 10. Accordingly, it should be understood that the exemplary components mentioned are not to be used to limit the features available on an IP appliance 10. On the IP appliance faceplate 18 may be an IP telephone keypad 28. The IP telephone keypad 28 may include several IP telephone keys 30 extending through the IP appliance faceplate 18. The IP telephone keys 30 may be the alphanumeric keys commonly found on a conventional telephone set. For example, IP telephone keys 30 may represent the numbers 0-9, as well as alphabetical designations on IP telephone keys 30 numbered 2-9, as is understood by those having ordinary skill in the art. Additionally, the IP telephone keys 30 may include a star key (*) and a pound key (#) as is commonly found on a conventional telephone set.

In addition to the IP telephone keys 30, the IP appliance 10 may include IP telephone function keys 32. The IP telephone function keys 32 may be predefined to perform a particular function such as pick up, transfer/conference, redial, pause, speed dial program, hold, volume control, speaker, message, mute, or the like.

The IP appliance 10 may also contain additional IP telephone function keys 34. The additional IP telephone function keys 34 may be programmable keys or buttons. That is, the additional IP telephone function keys 34 may be programmed by the user to perform a particular function, for example, paging, connecting to voice mail, connecting to voice memo, parking a call, speed dialing a phone number, or the like.

Additionally, the IP appliance 10 includes an IP appliance housing speaker 36 and an IP appliance housing microphone 38 accessible through the IP appliance faceplate 18. Additionally, incorporated in the IP appliance faceplate 18 may be an IP appliance liquid crystal display (LCD) 40. The IP appliance LCD 40 may be relatively small. The IP appliance LCD 40 can display various text based messages, for example, caller ID, date, time, amount of time spent on a call, number of voice messages in the voice mailbox, or the like.

The IP telephone 12 further includes a handset 42. The handset 42 may be a wireless handset or a corded handset, as is understood by those having ordinary skill in the art. The handset 42 includes a handset microphone 44 and a handset speaker 46 (actual configuration not shown for sake of brevity). On a faceplate (not shown) of the handset 42, there may be a keypad with telephone keys and function keys.

The IP appliance 10 also includes several means of connecting the IP appliance to an IP network (as further described below). These means are generally designated as IP connector 48. For example, contained within the IP appliance housing 16, a PCMCIA card slot(s), generally designated 50, may be mounted and electrically coupled to the components of the IP appliance 10. The PCMCIA card slot 50 is compatible with receiving a wireless adapter card 52. The wireless adapter card 52 includes a wireless antenna 54 on an end thereof. When the wireless adapter card 52 is inserted in the PCMCIA card slot 50 and operationally connected to the IP appliance 10, the wireless adapter card 52 allows the IP appliance 10 to be wirelessly connected to an IP network, as is understood by those having ordinary skill in the art. Alternatively, the components of a wireless adapter card 52 and the wireless antenna 54 may be integrated into the IP appliance housing 16.

Additionally, the IP appliance 10 includes a wired connection to the IP network. That is, the IP appliance 10 includes an IP cable 56. The IP cable 56 may be, for example, an Ethernet based cable, T1 line, USB cable, serial cable, parallel cable, or the like. The IP cable 56 is an alternative to wirelessly connecting to the IP network via the wireless adapter card 52.

In one embodiment, the IP appliance 10 includes a wired connection to a PSTN network. A PSTN cable 58 represents the wired connection. The PSTN cable 58 may include a RJ-11 jack, for example, for conventionally connecting the IP appliance 10 to a PSTN network, as will be understood by those having ordinary skill in the art. The PSTN cable 58 for connecting the IP appliance 10 to the PSTN network is optional.

The IP appliance 10 and/or the IP telephone 12 may receive power through one or more of the cables, i.e., the IP cable 56 or the PSTN cable 58. In one embodiment, the IP appliance 10 includes a power cord 60 electrically coupled to the components of the IP appliance 10 in order to provide power thereto when the plug containing end is plugged into a conventional wall outlet. Alternatively, rechargeable batteries may power the IP appliance 10.

Referring now to the first handheld device 14 illustrated in FIG. 1, the first handheld device 14 includes a first handheld device housing 62. The first handheld device housing 62 includes a first handheld device faceplate 64. The first handheld device faceplate 64 includes a first handheld device LCD 66. The first handheld device LCD 66 may be used to input and display data for running applications contained on the first handheld device 14, as is understood by those having ordinary skill in the art. The first handheld device LCD 66 may be a touch sensitive LCD.

Additionally, the first handheld device 14 may include first handheld device keys 68. The first handheld device keys 68 may be function keys and/or keys configured to represent a miniature keyboard and/or telephone keypad. Alternatively, the keys may be displayed on the first handheld device LCD 66 described above.

With reference to FIG. 2, the IP appliance 10 is shown in combination with the first handheld device 14 in an operational configuration. The IP appliance power cord 60 is connected to a power source (not shown). Further, the wireless adapter card 52 is shown inserted into the PCMCIA card slot 50 with the wireless antenna 54 exposed and operationally connected to the IP network wirelessly. Additionally, the IP cable 56, although optional when wirelessly connected, is shown operationally coupled to an IP network (not shown). The PSTN cable 58, although optional, is operationally coupled to a PSTN network (not shown). The first handheld device 14 is shown operationally connected to the IP appliance 10 via the IP appliance universal connector 20.

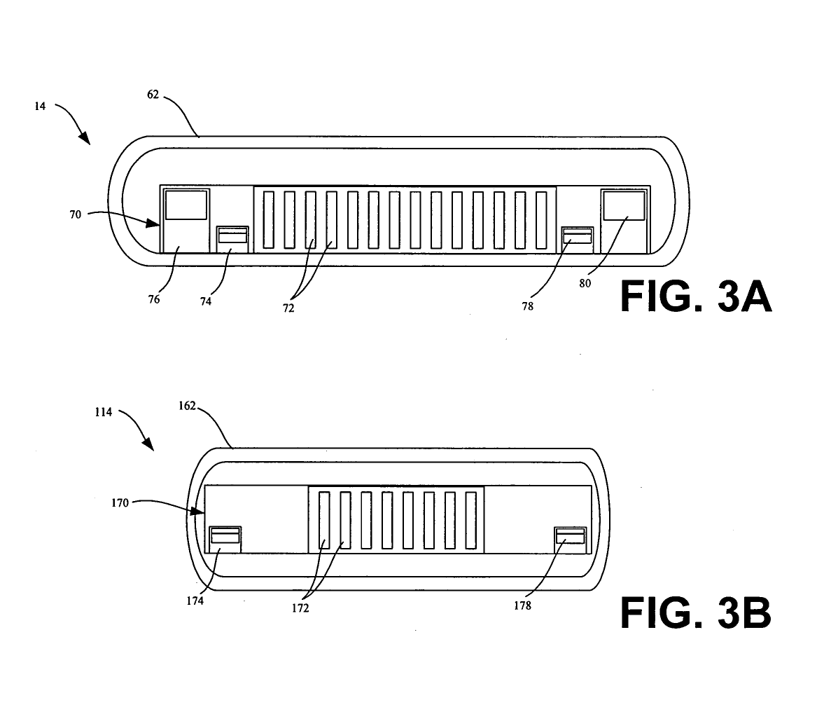

Referring now to FIGS. 3A and 3B, handheld connectors are shown that are compatible with the IP appliance universal connector 20. Referring initially to FIG. 3A, a first handheld device sixteen-pin universal connector, generally designated as 70, is shown. The handheld device sixteen-pin universal connector 70 includes first handheld device universal connector pins 72. The first handheld device universal connector pins 72 partially extend from the base of a first handheld device housing 62. The handheld device sixteen pin universal connector 70 also includes a first handheld device primary locking device 74 and a first handheld device secondary locking device 76. The first handheld device primary and secondary locking devices 74 and 76 are used by the first handheld device 14 to fixedly secure the first handheld device 14 to the IP appliance 10 for use therewith as will be further described below. As mentioned above, a locking mechanism is not required when the IP appliance 10 is connected wirelessly to a handheld device 14. However, a locking mechanism may be provided to physically secure the handheld device 14 in the IP appliance 10 for the convenience of the user. Alternatively, the locking mechanism described above may be provided to physically secure the handheld device 14 to the IP appliance 10 for charging the handheld device as described below. The first handheld device primary and secondary locking devices 74 and 76 may include a first handheld device primary locking detent 78 and a first handheld device secondary locking detent 80, respectively. The IP appliance universal connector primary locking pin 24 (FIG. 1) is designed to be inserted into the first handheld device primary locking device 74 to retain the first handheld device 14 with the IP appliance 10. When the first handheld device is retained as described above, the first handheld device sixteen pin universal connector 70 is electrically coupled to the IP appliance universal connector 20 via the IP appliance universal connector pins 22. Likewise, the IP appliance universal connector secondary locking pin 26 (FIG. 1) is designed to be inserted into the first handheld device secondary locking device 76 to retain the first handheld device 14 with the IP appliance 14. The secondary features provide additional assurance that the first handheld device 14 is physically and electrically coupled to the IP appliance 10.

If the locking pins are spring loaded as described above, the spring-loaded IP appliance universal connector primary locking pin 24 will travel into the first handheld device primary locking device 74 until reaching the first handheld device primary locking detent 78. Upon reaching the first handheld device primary locking detent 78, the end portion would extend further into the detent to lock the IP appliance universal connector primary locking pin 24 in place. Likewise, the IP appliance universal connector secondary locking pin 26 travels into the first handheld device secondary locking device 76 until reaching the first handheld device secondary locking detent 80. Upon reaching the first handheld device secondary locking detent 80, the end portion would extend further into the detent to lock the IP appliance connector secondary locking pin 26 in place. Alternatively, a bump (not shown) may be formed in the first handheld device primary locking device 74 and/or the first handheld device secondary locking device 76 over which the spring-loaded end portion would readily pass over in a first direction. However, the bump would inhibit the spring-loaded end portion from passing in a second direction opposite the first direction.

Turning now to FIG. 3B, similar elements have been given similar reference numbers incremented by a factor of 100 to facilitate the description. A second handheld device housing 162 including a handheld device eight-pin connector 170 is shown. As in the prior embodiment, the handheld device eight pin connector 170 includes second handheld device connector pins 172 and a second handheld device primary locking device 174. In this embodiment, the handheld device connector has eight pins 172 that are wired identical to the eight central pins of the handheld device sixteen pin universal connector 70. Consequently, the eight pins 172 can be electrically coupled to the central eight pins of the IP appliance universal connector 20 of the IP appliance 10 and provide a connection to a second handheld device 114 having the handheld device eight pin connector 170 versus having the handheld device sixteen-pin universal connector 70 (FIG. 3B).

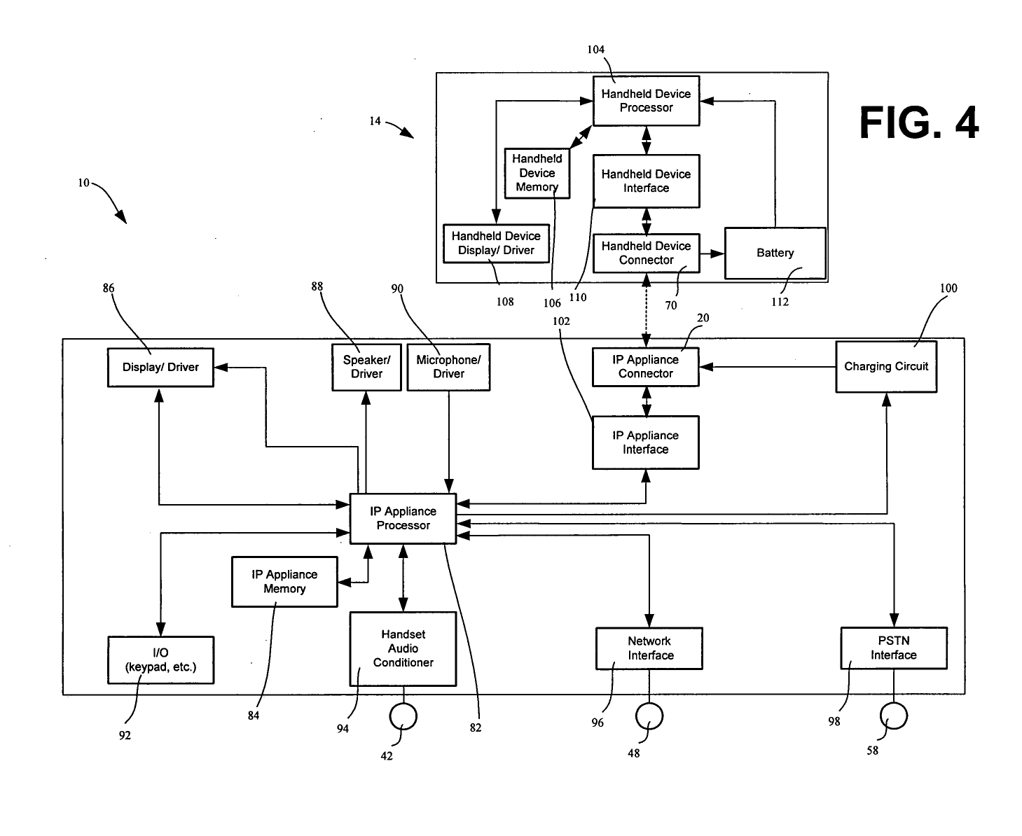

Referring now to FIG. 4, a detailed block diagram of the IP appliance 10 in accordance with an exemplary embodiment is shown. The IP appliance 10 includes an IP appliance processor 82 for running applications maintained within an IP appliance memory 84. The IP appliance processor 82 is coupled to the IP appliance LCD display 40 (FIG. 1) via an LCD display driver 86 such that the LCD display can be used to input and output data as described above. The IP appliance processor 82 is also coupled to the IP appliance LCD display driver 86 to provide a control signal, for example, a disable signal, thereto. The disable signal is used to disable the IP appliance LCD display 40 when the first handheld device 14 is operationally connected to the IP appliance 10. The display of the first handheld device 14 may then serve as the display for the IP appliance 10.

Additionally, the IP appliance processor 82 is coupled to the IP appliance housing speaker 36 (FIG. 1) via a speaker driver 88. This connection transmits audio data to the IP appliance housing speaker 36. The IP appliance processor 82 is also coupled to the IP appliance housing microphone 38 (FIG. 1) via a microphone driver 90. This connection transmits audio data received by the IP appliance housing microphone 38 to the IP appliance processor 82 for further processing. For example, the IP appliance processor 82 may packetize the audio data for transmission over a VoIP network. Alternatively, IP appliance processor 82 may process the audio data for transmission over a PSTN network. The IP appliance processor 82 may also process the audio data for storage in the IP appliance memory 84. Further, the IP appliance processor 82 may process the audio data to use in running applications on the first handheld device 14 and/or the IP appliance 10.

Further, the IP appliance processor 82 is coupled to an input/output interface 92 for operationally connecting input and/or output devices to the IP appliance 10. The input and/or output devices include, for example, a keyboard, monitor, keypad, or the like. The keypad may be, for example, the IP telephone keypad 28, the IP telephone function keys 32, the additional IP telephone function keys 34, or the like. The input/output interface 92 may include hardware and/or software necessary to transmit and receive compatible data between the attached device and the IP appliance 10.

The IP appliance processor 82 may also be coupled to a handset audio conditioner 94. The handset audio conditioner 94 conditions the signal provided to the handset 42 has understood by those having ordinary skill in the art. The handset audio conditioner 94 is coupled to the handset 42.

Additionally, the IP appliance processor 82 is coupled to a network interface 96. The network interface 96 electrically couples the IP connector 48 connected to an IP network to the IP appliance processor 82. The network interface 96 may include hardware and/or software necessary to transmit and receive compatible data between the IP network and the IP appliance 10. The hardware could include, for example, a network interface card, a modem, other adapters, the cabling therebetween, the wiring therebetween, or the like. The software may include, for example, drivers, protocols such as token ring, NetBEUI, TCP/IP, Ethernet, 802.11x, Bluetooth, IR, or the like.

The IP appliance processor 82 is coupled to a PSTN interface 98. The PSTN interface 98 is optional. The PSTN interface 98 electrically couples the PSTN cable 58 connected to a PSTN network to the IP appliance processor 82. The network interface 96 may include hardware and/or software necessary to transmit and receive compatible data between the PSTN network and the IP appliance 10.

In one embodiment, the IP appliance processor 82 is coupled to a charging circuit 100. In turn, the charging circuit 100 is coupled to the IP appliance connector 20. The IP appliance processor 82 controls the charging circuit 100 via a control signal. The control signal determines whether a charge is supplied to the IP appliance connector 20 in order to charge a handheld device connected thereto.

Additionally, the IP appliance processor 82 is coupled to an IP appliance interface 102, which in turn is coupled to the IP appliance connector 20. The IP appliance interface 102 may include hardware and/or software necessary to transmit and receive compatible data between a handheld device and the IP appliance 10. The hardware could include, for example, a network interface card, a modem, other adapters, the cabling therebetween, the wiring therebetween, or the like. The software may include, for example, drivers, protocols such as token ring, NetBEUI, TCP/IP, Ethernet, 802.11x, Bluetooth, IR, or the like. Thus, handheld device 14 electrically coupled to the IP appliance 10 via the IP appliance interface 102 can exchange compatible data between the devices.

The first handheld device 14 includes a first handheld device processor 104 for running applications maintained within a first handheld device memory 106. The first handheld device processor 104 is coupled to a first handheld device LCD display driver 108. The first handheld device LCD display driver 108 allows the first handheld device LCD 66 (FIG. 1) to be used as an input/output interface for the user.

Additionally, the first handheld device processor 104 is coupled to a first handheld device interface 110 that in turn is coupled to the first handheld device sixteen pin universal connector 70. The first handheld device interface 110 may include hardware and/or software necessary to transmit and receive compatible data between a handheld device and the IP appliance 10. The hardware could include, for example, a network interface card, a modem, a wireless adapter card, IR adapter, other adapters, the cabling therebetween, the wiring therebetween, or the like. The software may include, for example, drivers, protocols such as token ring, NetBEUI, TCP/IP, Ethernet, 802.1 lx, Bluetooth, IR, or the like. Thus, handheld device 14 electrically coupled to the IP appliance 10 via the first handheld device interface 110 can exchange compatible data between the devices.

The first handheld device processor 104 is coupled to a battery 112. The first handheld device processor 104 controls the charge being applied to the battery 112 for charging when the first handheld device 14 is connected to the IP appliance 10. An output of the battery 112 is connected to the first handheld device processor 104 to provide power thereto.

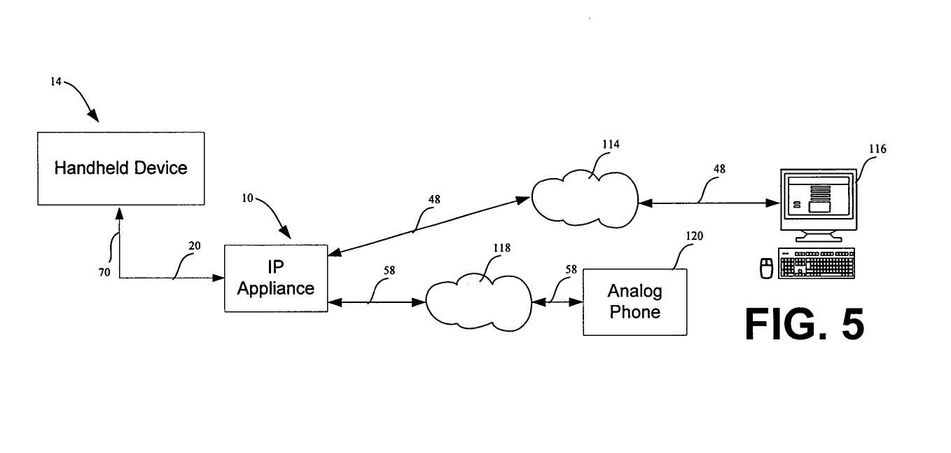

Referring now to FIG. 5, the first handheld device 14 is shown electrically coupled via the handheld device sixteen-pin universal connector 70 and the IP appliance universal connector 20 to the IP appliance 10 of FIG. 1. The IP appliance 10 is electrically coupled to an IP network 114 via the IP connector 48. A multimedia computer 116 is also connected to the IP network 114 via another IP connector 48. The IP appliance 10 is further connected to a PSTN network 118 via a PSTN cable 58 that includes, an RJ-11 jack, for example. Additionally, an analog phone 120 is connected to the PSTN network 118 via a PSTN cable 58.

The IP appliance 10, connected as described above, has several advantages over present IP telephones and/or handheld devices that are connected independently to an IP network and/or a PSTN network. For example, the IP appliance with the handheld device electrically coupled thereto can now use the features of the handheld device in order to make and receive a telephone call. The telephone call can be made over a traditional PSTN connection or alternatively, over an IP network 114 including a VoIP system.

The VoIP system may be any system capable of transmitting and receiving voice data over an IP network. The VoIP system may be a digital data network over which digitized voice signals are transmitted as a stream of packets. The underlying digital data network may be an IP network, for example, a proprietary network, a network of leased facilities, the Internet, an Intranet, a WAN, a LAN, a virtual private network (VPN), or the like, or a combination thereof. The VoIP system may be a VoIP system as described in U.S. patent Ser. No. 10/036,001 by Jian Min Wu et al., Ser. No. 10/036,024 by Haung-Ming Pan, Ser. No. 10/036,561 by Shih-An Cheng et al., Ser. No. 10/046,356 by Shih-An Cheng et al., or Ser. No. 10/0356,628 by Jian Min Wu et al., which are hereby incorporated by reference in their entirety.

In general terms, a VoIP client connects to a VoIP network to make and receive VoIP calls. The VoIP network includes various network components, for example, routers, gateways, VoIP servers or the like, interconnected into a network capable of transmitting and receiving voice data. VoIP networks are connected to conventional PSTN networks to make and receive VoIP calls with PSTN telephones.

In this manner, the handheld device, for example, a cell phone, a combination phone/PDA, a PDA equipped with a wireless phone capability or the like, can now use either the PSTN network or the VoIP network to complete the call. Using the PSTN network 118 and/or the VoIP network can reduce the cost of making and receiving such calls.

Additionally, the handheld device 14 connecting via the IP connector 48 can transmit and receive data via the IP network 114 to a multimedia computer 116 connected to the IP network 114. For example, a mobile user can synchronize data created on the handheld device 14 during a mobile operation and transfer such data onto the multimedia computer 116 for further processing. Alternatively, the handheld device 14 can retrieve e-mail messages from the multimedia computer 116 or mail server also the connected IP network 114 and store such messages for later review while the user is mobile. Further still, the handheld device can retrieve from a voice mailbox an audio message that can be played later at a more convenient time for the mobile user. Further still, the handheld device 14 can be used to make the call using a contact or phone book contained thereon. Additionally, the contact information can be synchronized with the contact information maintained on the multimedia computer 116 or on a cell phone. Accordingly, the user can be assured that his contacts are up to date when the user is traveling. Further, while the handheld device 14 is electrically coupled to the IP appliance 10, the handheld device 14 can surf the IP network 114 (for example, the world wide web) based on predefined criteria and update the web sites of interest to the user for further review later. Another advantage of the present invention is the ability to charge the handheld device 14 while the handheld device 14 is electrically coupled to the IP appliance 10.

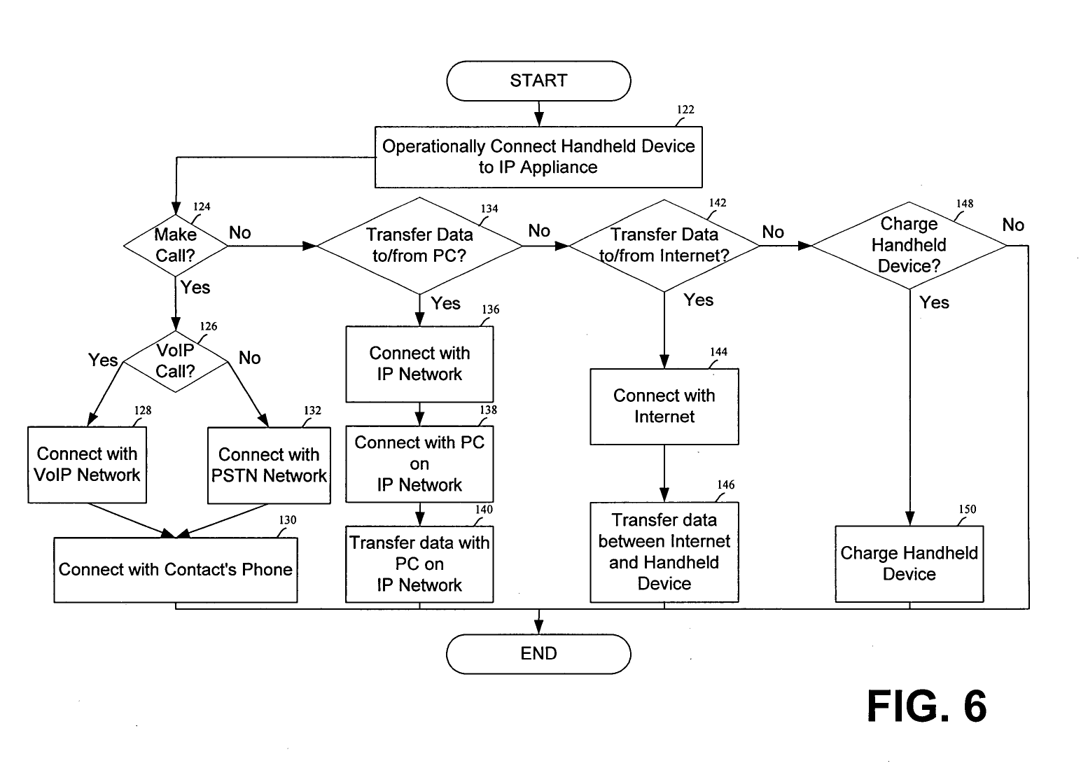

The steps of a method of using the handheld device connected to the IP appliance 10 will now be further explained with reference to FIG. 6. In step 122, a user operationally connects the handheld device to the IP appliance 10. That is, a user physically lines up the IP appliance universal connector 20 with the first handheld device sixteen pin universal connector 70. Next, the user pushes the first handheld device 14 in an engagement direction until the first handheld device primary locking devices 74 and the first handheld device secondary locking devices 76 fixedly secure the handheld device 14 to the IP appliance 10 in a physical and an operational manner as described above.

Once the first handheld device 14 is connected to the IP appliance 10, a disable signal is sent to the IP appliance LCD to disable it. Thus, the first handheld device LCD display can be used as the interface between the user and application's the user wishes to run. The applications can be in the memory of the IP appliance 10 and/or the memory of the first handheld device 14. Alternatively, the application could be in the memory of another device, for example, a PC attached to the IP network.

The first handheld device 14 can be connected to the IP appliance 10 in a standby mode until the user decides to run an application. The applications can be represented to the user in the first handheld device LCD as an icon in a main display, an icon in a “launch tray”, an icon on a dropdown menu, a shortcut, or the like. The user can select the application to be run by clicking on the icon with the cursor via the mouse or keyboard. The user may “double click”, “single click”, selecting the icon with a “single click” and then press enter, or the like, in order to run or execute an application. As theses features are understood by those having ordinary skill in the art, for brevity sake, specific details of running applications on the first handheld device 14 will be omitted.

When a user decides to run an application to make a call, synchronize data, transfer data between a PC or the Internet, charge the handheld device or the like, the user selects and activates the application represented by the icon on the first handheld device LCD display 66. The user may select the icon by using the curser, a stylus, and a finger if the LCD is touch sensitive, or the like.

In step 124, the user decides whether to make a call. If the user decides to make a call, then in step 126, the user must decides whether to make a VoIP call or a PSTN call. If the user decides affirmatively to make a VoIP call, then in step 128, the user can select a VoIP application represented by an icon on the first handheld device LCD display 66. The VoIP application can present several options to the user, for example, the user can select a phone number for autodial from a contact list maintained on the first handheld device 14. Alternatively, the user could select to use a keypad displayed on the first handheld device LCD 66 to input a phone number or IP address. Once a number is selected, the IP appliance 10 initiates a call on the VoIP system via the IP telephone 12. The call can be conducted using the housing speaker and microphone. Alternatively, the user may pick up the handset of the IP telephone 12. The IP telephone 12 transmits a client query to the VoIP network and precedes to connect with the VoIP network as is understood by those having ordinary skill in the art. In step 130, the VoIP network establishes the call in an otherwise conventional manner with the contact's phone. When the phone call is over, the user disconnects in a conventional manner, for example, the user places the handset back on the IP appliance 10, or pushes the “end” button on the handset keypad, the IP telephone keypad 28 or the first handheld device LCD 66.

If in step 126, the user decides to make a PSTN phone call, then the user in step 132 makes a PSTN phone call. The user selects an icon representing an application for making a PSTN call. The program may include several of the features discussed above with regard to the VoIP application. After the phone number is entered, the PSTN phone call is made in a conventional manner as is understood by those having ordinary skill in the art.

If in step 124 the user decides not to make a call, then the user can decide whether to transfer data to/from a PC in step 134. If the user affirmatively decides to transfer data to/from a PC, then the user, in step 136, can select an application for transferring data between devices over an IP network represented by an icon on the first handheld device LCD display 66. The transfer data between devices over an IP network application can present several options to the user; for example, the user can select an icon representing the device that the user wants to transfer data between from a list maintained on the first handheld device 14. Next, the user connects with an IP network via the IP connector 48. That is, the IP appliance 10 connects with the IP network 114 either through the IP cable 56 or through the wireless adapter card 52. Next, in step 138, the user locates the PC on the IP network using an IP address, for example. The user connects to the PC in a conventional manner, for example, using a domain name (user ID) and password. Once the user is logged in, then in step 140, the user can transfer data between the PC and the handheld device 14 by dragging and dropping files, or the like, as is understood by those having ordinary skill in the art.

If in step 134 the user decides not to transfer data to/from a PC, then, in step 142, the user can decide whether to transfer data to/from the Internet. If the user affirmatively decides to transfer data to/from the Internet, then the user can select an application for transferring data between devices on the Internet represented by an icon on the first handheld device LCD display 66. The transfer data between devices on the Internet application can present several options to the user, for example, the user can preset criteria about a web page of interest that the user wants to transfer data from. That is, the user can set criteria like download web page when web page is updated, for example. Next, the user, in step 144, connects with the Internet via the IP connector 48 and a browser displayed on the first handheld device LCD display 66 as is conventional. Next, the user locates the information of interest on the Internet using a search engine, for example. Once the user locates data to be transferred, then in step 146, the user transfers the data between the Internet and the handheld device 14 in a conventional manner as is understood by those having ordinary skill in the art.

If in step 142 the user decides not to transfer data to/from the Internet, then, in step 148, the user can decide whether to charge a battery in the first handheld device 14. If the user affirmatively decides to charge the battery in the first handheld device 14, then the user, in step 150, activates the battery charger via the first handheld device LCD. Once the battery is fully charged, the first handheld device 14 will automatically disable the charging circuit. If the user does not want to charge the battery in the first handheld device, then the first handheld device 14 can sit in the “cradle” until the user decides to run an application thereon. Alternatively, if the user has completed the tasks on the IP appliance, the user can remove the first handheld device 14 in order to carry the handheld device to another location.

Thus, there has been disclosed a system and method of connecting a handheld device to an IP appliance. The IP appliance may connect to a VoIP network to make a VoIP call. Further, the IP appliance may connect to a PSTN network to make a PSTN call. This method permits the more efficient use of the handheld device and the IP appliance by allowing the synchronization of data, e.g., contact information.

It will be appreciated that each of the respective devices described herein is programmed via conventional computer programming techniques to execute machine-readable code in order to carry out the operations described herein. Such programming may be easily performed by those having ordinary skill in the art of computer programming and IP technology based on the disclosure herein. Accordingly, the particular details of such programming code have been omitted for the sake of brevity.

Although particular embodiments of the invention have been described in detail, it is understood that the invention is not limited correspondingly in scope, but includes all changes, modifications and equivalents coming within the spirit and terms of the claims appended hereto. For example, although the flow chart of FIG. 6 shows a specific order of execution, it is understood that the order of execution may differ from that which is depicted. The order of execution of two or more blocks may be scrambled relative to the order shown, for example. In addition, two or more blocks shown in succession in FIG. 6 may be executed concurrently or with partial concurrence.

1. An Internet Protocol (IP) appliance, comprising:
an IP telephone including a housing;
an IP appliance connector mounted to the housing and configured to operationally connect with a connector of a handheld device; and
a network connector mounted to the housing and configured to operationally connect to a network;
wherein when the handheld device is operationally connected to the IP appliance connector, the handheld device can transmit and receive data via the network.

2. The IP appliance according to claim 1, wherein the IP appliance connector is a universal connector.

3. The IP appliance according to claim 1, wherein a liquid crystal display of the handheld device can be used to run applications on the IP appliance when the handheld device is operationally connected thereto.

4. The IP appliance according to claim 1, wherein the handheld device can be used to make a VoIP call over a VoIP network through the IP appliance.

5. The IP appliance according to claim 1, wherein the handheld device can be used to make a PSTN call over a PSTN network through the IP appliance.

6. The IP appliance according to claim 1, wherein the handheld device can transmit and receive data from a personal computer connected to the network.

7. The IP appliance according to claim 1, wherein the handheld device can synchronize data between a personal computer connected to the network and the handheld device.

8. The IP appliance according to claim 1, wherein the handheld device is a Personnel Data Assistant (PDA), a cell phone, a pager, an MP3 player or a combination thereof.

9. The IP appliance according to claim 3, wherein the handheld device includes a universal connector.

10. The IP appliance according to claim 1, wherein the network includes:
an IP network configured to allow voice data to be transmitted and received over the IP network; and
a PSTN network configured to complete a call over the PSTN network.

11. The IP appliance according to claim 3, wherein the IP network comprises one or more of a proprietary network, a network of leased facilities, the Internet, an Intranet, a wide-area network (WAN), a local-area network (LAN) and a virtual private network (VPN).

12. A method for using a handheld device connected to an IP appliance, wherein the IP appliance comprises; an IP telephone including; an IP appliance connector for connecting with a handheld device; a connector for connecting to a VoIP network; a microphone for receiving voice data; and a speaker for transmitting voice data; comprising the steps of:
(a) operationally connecting the handheld device to the IP appliance;
(b) operationally connecting to a network via a network connector mounted to an IP appliance housing; and
(c) transmitting and receiving data via the network.

13. The method according to claim 12, further including the step of;
(d) using a liquid crystal display of the handheld device to run applications on the IP appliance when the handheld device is operationally connected thereto.

14. The method according to claim 12, further including the step of;
(e) making a VoIP call over a VoIP network through the IP appliance using the handheld device.

15. The method according to claim 12, further including the step of;
(f) making a PSTN call over a PSTN network through the IP appliance using the handheld device.

16. The method according to claim 12, further including the step of;
(g) transmitting and receiving data between a personal computer connected the network and the handheld device through the IP appliance.

17. The method according to claim 12, further including the step of;
(h) synchronizing data between a personal computer connected to the network and the handheld device through the IP appliance.
